(19) United States
(12) Patent Application Publication
(10) Pub. No.: US 2017/0256015 A1
(43) Pub. Date: Sep. 7, 2017

(54) GEOCODED LOCATION AND PRICE MATCHING

(71) Applicants: Emanuel Moecklin, Hampton, NH (US); Martin Hoch, Lakewood, NY (US); Robert Nioras, Rye Brook, NY (US); Michael Dearman, Lakewood, NY (US); Paige Porter-Buhl, Gainesville, FL (US); Gerry Barbera, Messina (IT); Sam McNitt, Jamestown, NY (US)

(72) Inventors: Emanuel Moecklin, Hampton, NH (US); Martin Hoch, Lakewood, NY (US); Robert Nioras, Rye Brook, NY (US); Michael Dearman, Lakewood, NY (US); Paige Porter-Buhl, Gainesville, FL (US); Gerry Barbera, Messina (IT); Sam McNitt, Jamestown, NY (US)

(21) Appl. No.: 15/446,815

(22) Filed: Mar. 1, 2017

Related U.S. Application Data
(60) Provisional application No. 62/301,905, filed on Mar. 1, 2016.

(51) Int. Cl. G06Q 50/30; G06Q 30/06; G01S 19/46; G06Q 30/02

(52) U.S. Cl. CPC G06Q 50/30; G06Q 30/0284; G06Q 30/0611; G01S 19/46

(57) ABSTRACT

To improve pricing models for location based services, established geocoding/reverse geocoding services are used to enrich the locations defining the price item (start location, multiple end locations) and the pick-up/drop-off location with geocoding information like zip codes, coordinates and geographic boundaries. A multi-step matching algorithm then uses the geocoding values to determine 1) if there is a match between locations and 2) how good of a match there is. The match is measured by its “order.” For example, if the places are identical, they have a matching order 0, identical coordinates a matching order 1, matches based on zip codes have a matching order 2, matches based on geographic boundaries have a matching order 3, etc. Other sub-criteria, such as the number of zip codes or the size of an area, may also serve as tie-breaker. The order of the match may then be used to establish the correct predictive pricing model.

### CROSS-REFERENCE TO RELATED APPLICATIONS

This application claims priority to U.S. Provisional Patent Application Ser. No. 62/301,905 filed Mar. 1, 2016. The contents of that patent application are hereby incorporated by reference in their entirety.

### TECHNICAL FIELD

The invention provides computer-implemented techniques and systems for enabling the prediction and calculation of the costs of services to be performed at arbitrary locations using geocoding and, in an exemplary embodiment, to computer-implemented techniques and systems for calculating a pricing model, prior to the rendering of the service, for transportation based services such as transfers or food/product delivery when the pick-up and drop-off locations are arbitrary.

### BACKGROUND

The transportation and product delivery industries are rapidly changing. Transportation services such as Uber, Lyft, and the like incorporate computer technologies and geopositioning systems (GPS) to calculate the cost of transporting a person from one known location to another known location. Similarly, delivery services such as those provided by FedEx and Express Mail have systems that calculate the costs of transporting packages between known locations based on the size and weight of the package. However, these systems rely upon knowing the zip codes of the starting and endpoints of the transportation and do not prove useful when the starting and/or end points of the transportation are not pre-established or the geographic area is arbitrary.

Certain location based services including delivery services, transportation services, mail/carrier services, house call services, and the like have transportation costs worked into the service costs. However, the accuracy of the prediction of the services costs is particularly limited when the starting and/or end points of the transportation are not fixed. A clear example of this is where a hotel or other service agency provides a transportation transfer voucher for the costs of a customer to get from one location to another. For the true costs of a transportation voucher to be accurately calculated in advance, one would need all of the possible transportation providers and hosts (hotels, etc.) to work together in a coordinated way. For example, booking agents such as Travelocity, Booking.com, and Expedia provide transfers at set costs through existing service providers. However, the costs of such transfers are pre-negotiated and calculated based on fixed route—price relations. As a result, such transfers require the use of particular service providers only at specified pick-up and drop-off locations and the customer is not free to use other service providers in the immediate area. The systems are not robust enough to provide an open platform where a voucher may be used to compensate any service provider on the platform where prices for a transfer with arbitrary pick-up and drop-off locations may be calculated prior to rendering of the service. Current solutions do not provide an open service platform (covering all potential service providers that can handle the transfers) as they are based on hardwired relations between certain transfers and provider prices and thus are limited to certain pick-up and drop-off locations.

A system and method is desired that provides an open platform for providing transportation services where a particular vendor need not necessarily be selected in advance and the particular pick-up and drop-off locations are not specified in advance. The invention addresses these and other needs in the art.

### SUMMARY

The above-mentioned needs in the art are addressed by providing systems and methods that combine geocoding and a matching algorithm to enable transportation price prediction even when the exact pick-up and drop-off locations are not pre-specified. In particular, the invention uses established geocoding/reverse geocoding services to enrich the locations defining the price item (start location, multiple end locations) and the pick-up/drop-off location with geocoding information like zip codes, coordinates and geographic boundaries. A multi-step matching algorithm then uses the geocoding values to determine 1) if there is a match between locations and 2) how good of a match there is. The match is measured by its “order.” For example, if the places are identical, they have a matching order 0, identical coordinates a matching order 1, matches based on zip codes have a matching order 2, matches based on geographic boundaries have a matching order 3, etc. Other sub-criteria, such as the number of zip codes or the size of an area, may also serve as tie-breaker. The order of the match may then be used to establish the correct predictive pricing model.

Exemplary embodiments of the invention include a method and corresponding networked computer system for providing location based services, such as delivery services, transportation services, mail/carrier services, or house call services, according to a tiered pricing model based on proximity of the location based services to desired pick-up and/or drop-off locations. Such a method is characterized by the steps of receiving offers of location based services from service providers, where the offers include attributes of the offered location based services and geocoded GPS location data identifying where the location based service is offered and receiving from a consumer a request for location based services, where the request includes attributes of the requested location based services and geocode GPS location data identifying where the consumer wishes to receive the location based services. In each case, the geocoded location data includes at least two different types of geocoding information representing areas of different sizes. For example, the different types of geocoding information representing areas of different sizes may include at least two of an address, longitudinal/latitudinal coordinates, zip code, geographic boundaries, or landmark name. A matching algorithm then matches the received request to offers of location based services received from services providers. The matching is provided by a multi-step algorithm that determines if there is a geographic match between a requested location and an offered location for the location based services and, if so, determines an order of the geographic match based on the type of geocoding information that is found to match. Tiered pricing may then be provided for the requested location based service based on the order of the geographic match. In such case, the attributes of the location based services offered by the service providers include tiered pricing with a different price tier for each order of geographic match. The match results may then be sorted by closeness of geographic match between a requested location and an offered location for requested location based services and presented as so sorted or presented in a rank order sorted by price.

In the exemplary embodiments, the match results have a first matching order if the requested location and offered location have identical addresses or landmark name, a second matching order if the requested location and offered location have identical longitudinal/latitudinal coordinates, a third matching order if the requested location and offered location have matching zip codes, and fourth matching order if the requested location and offered location have matching geographic boundaries. In such case, the price for the requested location based service may increase as the order of the geographic match moves from the first to the fourth matching order. Sub-criteria such as a number of zip codes or a size of a geographic area within a geographic boundary may be used as tie breakers when the offered locations from different service providers have a match of the same matching order. The system may also provide a warning to a user if the user selects a pricing tier that is not a lowest predefined pricing tier or if the user selects a provider that does not have a predefined pricing tier and the user manually enters a price that is higher than a lowest predefined price.

These and other characteristic features of the invention will become apparent from the following detailed description of the invention.

### BRIEF DESCRIPTION OF THE DRAWINGS

The above and other characteristic features of the invention will be understood by those skilled in the art from the following detailed description of the invention in connection with the attached drawings, of which:

FIG. 1 provides a general overview of a method for providing location based services in accordance with the invention.

FIG. 2 provides an example of price matching for location based services where a food delivery service may have different prices based on the distance of the delivery location from the home base of the food delivery service (or the restaurants they serve).

FIG. 3 illustrates an interface through which a booking agent or guest would enter a pickup date/time and a pick-up location (in this case an airport).

FIG. 4 illustrates an interface through which a booking agent or guest would also enter a drop-off location by selecting the hotel they want to transfer to.

FIGS. 5A-5C illustrate an interface through which a booking agent or guest would enter the number of guests to transfer and information about the guests.

FIGS. 6A-6C illustrate the price list results that are provided to the booking agent or user based on the geocoded locations.

FIGS. 7A-7B illustrate an interface through which the booking agent or user may also add a new destination within a specific pricing tier using a sorted list of service providers.

FIG. 8 illustrates a pricing model with pricing tiers based on geo-coded information in accordance with the invention.

FIG. 9 illustrates the price matching for location based services as in FIG. 2 where the service is a transportation service having a tiered geo-coded pricing model in accordance with the techniques of the invention.

FIG. 10 illustrates a location matching/ranking algorithm in accordance with an exemplary embodiment of the invention.

FIG. 11 is a block diagram illustrating a computer architecture of the system through which the embodiments of the location based matching system of the invention may be implemented.

### DETAILED DESCRIPTION OF ILLUSTRATIVE EMBODIMENTS

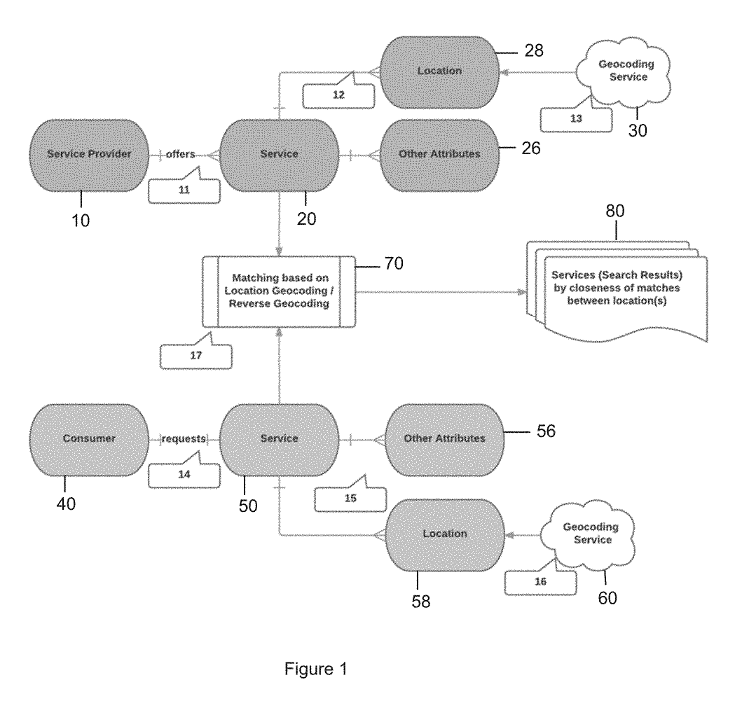

Certain specific details are set forth in the following description with respect to FIGS. 1-11 to provide a thorough understanding of various embodiments of the invention. Certain well-known details are not set forth in the following disclosure, however, to avoid unnecessarily obscuring the various embodiments of the invention. Those of ordinary skill in the relevant art will understand that they can practice other embodiments of the invention without one or more of the details described below. Also, while various methods are described with reference to steps and sequences in the following disclosure, the description is intended to provide a clear implementation of embodiments of the invention, and the steps and sequences of steps should not be taken as required to practice the invention.

Generally, the invention provides a method for service providers to offer location based services and to match those services to service requests by consumers. The matching/search uses multiple criteria to determine the quality of a match between different locations (the matching order) depending on what attributes are available for a specific location. As used herein, a “location” is any location with an address (country, city, street, and number), a landmark, a well-defined geographic area (country, city etc.), a pair of coordinates, a rectangle defined by two coordinates, or a geographic area defined by a polygon. Also, as used herein, a “location based service” is a service offered in or for a certain location (or multiple locations). Such services include but are not limited to: delivery services, transportation services, mailing/carrier services, house-call services, and the like.

As will be explained in detail below, the invention makes it possible to find location based services and to rank them according to how close the match between the locations are. For example, a traveler looking for a transfer from an airport to a hotel might find a company offering transportation from and to the city but the same company might also have a special airport transfer service offering transfers from the airport to and from the top hotels in the city. The provided method would return the airport transfer services first because the match between locations is closer.

FIG. 1 provides a general overview of a method for providing location based services in accordance with the invention. As illustrated, in accordance with the method a service provider 10 offers at 11 an arbitrary location based service 20. The service 20 is defined by several attributes 26 (price, availability, size, etc.) as well as by one or several locations 28. The locations 28 are geocoded/reverse-geocoded at 13 using arbitrary geocoding services 30 such as the geocoding (GPS) services provided by Google Maps, Bing Maps, OpenStreetMaps, and the like. As these services are widely used and well-known to those skilled in the art, they will not be described in detail herein. Each service provider 10 to be included on the matching platform would provide such geocoded/reverse geocoded location and attribute information into a database of the matching platform.

To initiate the matching process, a consumer 40 requests or searches at 14 for a service 50. The requested service 50 is defined by several attributes 56 (price, availability, size, etc.) but also by one or several locations 58. The locations 58 are geocoded/reverse-geocoded at 16 using arbitrary geocoding services 60 such as the geocoding services provided by Google Maps, Bing Maps, OpenStreetMaps, and the like. The system implements a matching algorithm 70 at 17 that matches the offered service 20 and the requested service 50 based on how close the geocoding/reverse geocoding matching between the locations are. The other attributes are included by the matching method as well, but such attributes are matched in a conventional fashion and thus will not be discussed in detail herein. The search (matching) results are provided to the consumer at 80 and are prioritized by closeness of the matches between locations 28 and 58.

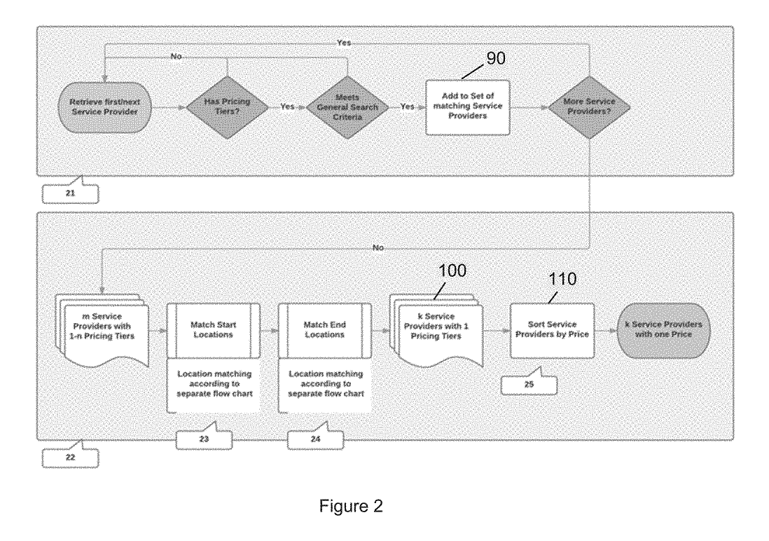

The matching provided at 70 is best described in the context of specific examples. FIG. 2 provides an example of price matching for location based services where a food delivery service may have different prices based on the distance of the delivery location from the home base of the food delivery service (or the restaurants they serve). Pricing tiers would define prices based on the amount of ordered food, the time of day, the day of the week (more expensive on weekends), and the time to deliver (distance). The method allows automatic matching of delivery locations to locations used to define the pricing tiers even if the nature of these locations is different (typically the delivery location would be an address while the pricing tier location could be a borough, a city, a set of zip codes or even an area on the map defined by a polygon).

The method of initiating a price search/matching for multiple food delivery services is initiated at 21 by retrieving service providers with pricing tiers that meet the general search criteria. A set of matching service providers is created at 90. In step 22, the service providers and the service offerings of those service providers are filtered by locations (start locations as in home base location/restaurant location and end location as in delivery location). At step 23, the start location (m service providers or restaurants) is matched to the start locations attached to the 1-n pricing tiers, and the service providers without a matching pricing tier/location are eliminated. Every match is ranked according to how close the locations match. At step 24, the end location (delivery address) is matched to the end locations attached to the pricing tiers, and service providers without a matching pricing tier/location are eliminated. Again, every match is ranked according to how close the locations match. The result is a set of k service providers with different pricing tiers at 100. At step 25, multiple matches per service provider are already reduced to one match using the computed ranking (the order of the match) 100. The lower the matching order, the better the fit. For example, if the places are identical, they have a matching order 0, identical coordinates a matching order 1, matches based on zip codes have a matching order 2, matches based on geographic boundaries have a matching order 3, etc. Other sub-criteria, such as the number of zip codes or the size of an area, may also serve as tie-breaker. The resulting list of service providers is now sorted by price at 110 to get the best price for that specific delivery. The result is the k service providers of the m available service providers that satisfy the price in a given pricing tier.

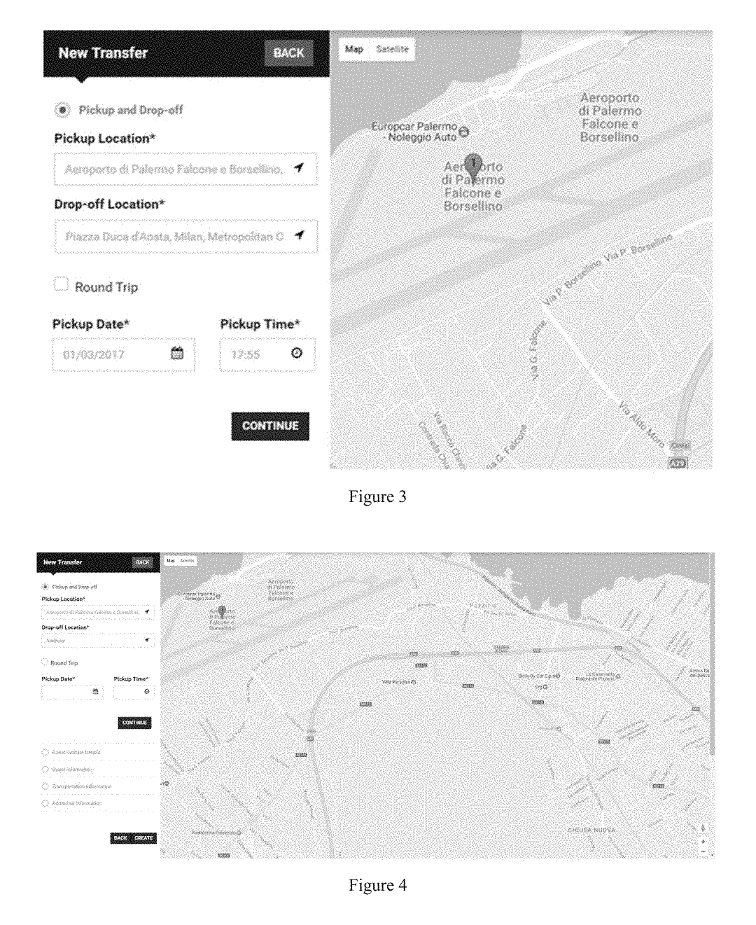

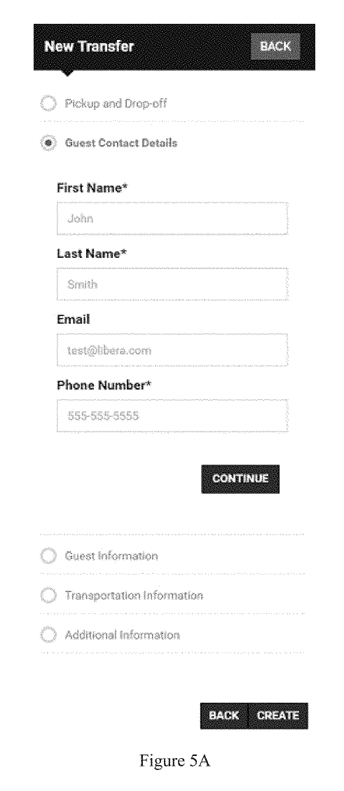

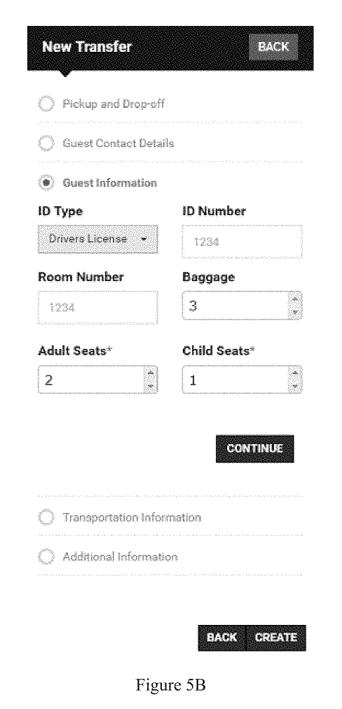

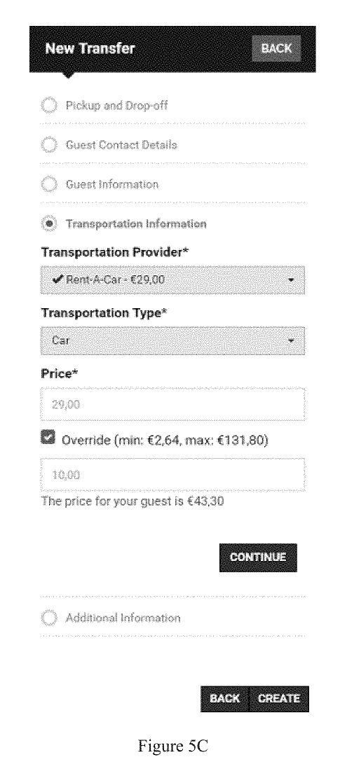

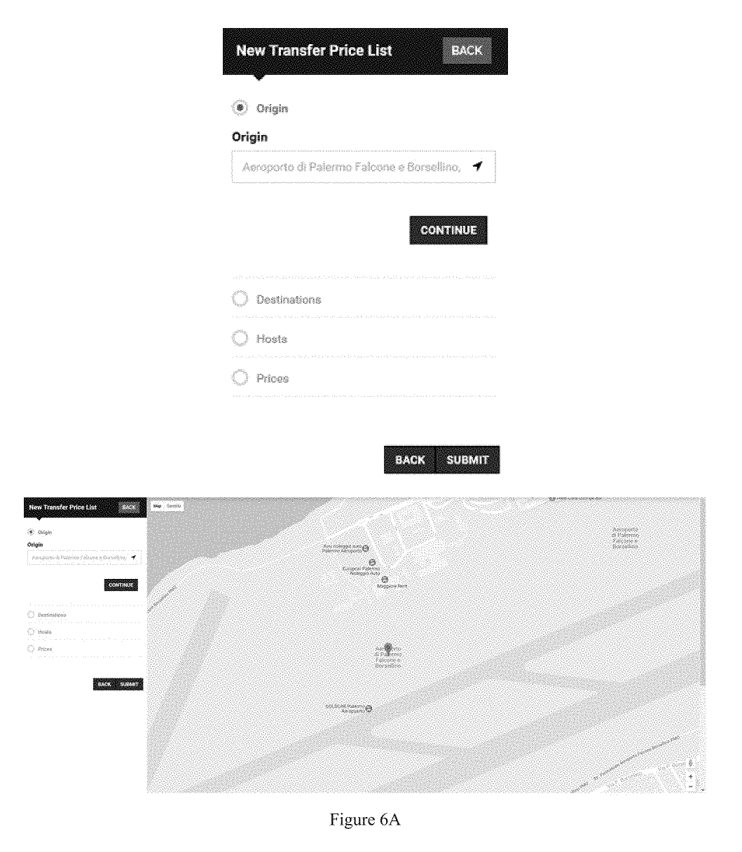

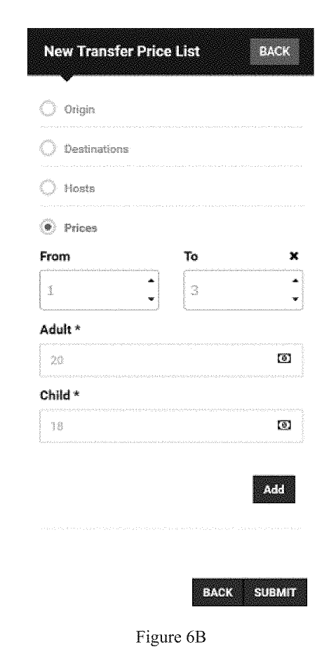

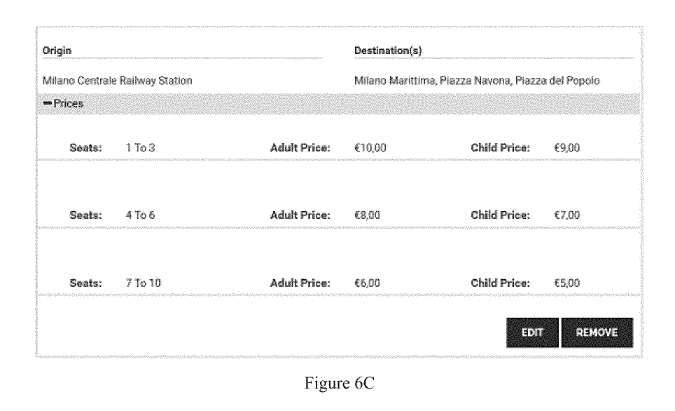

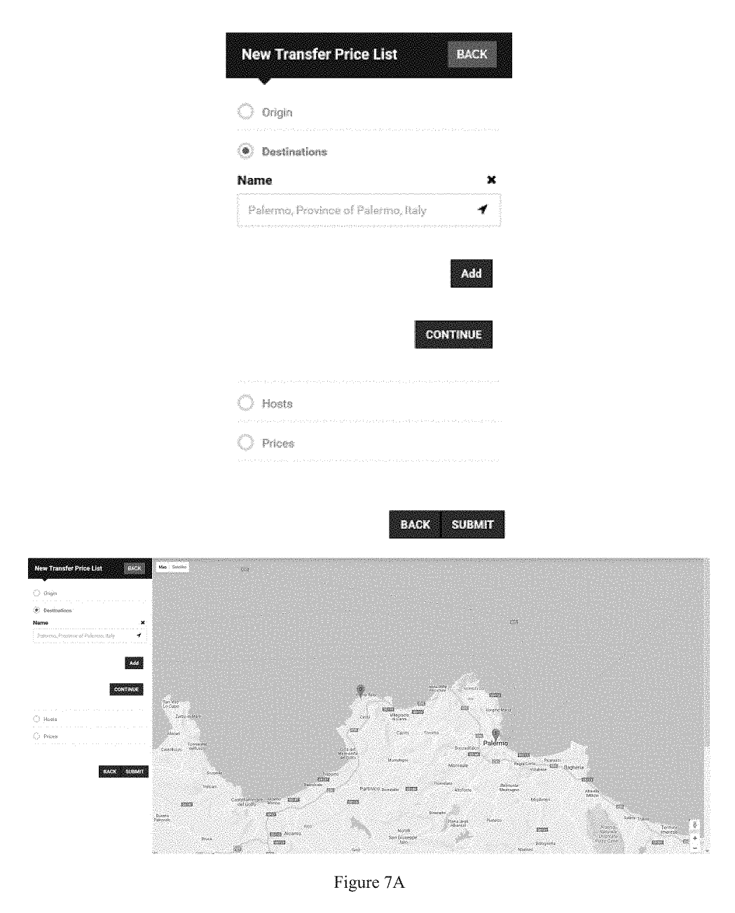

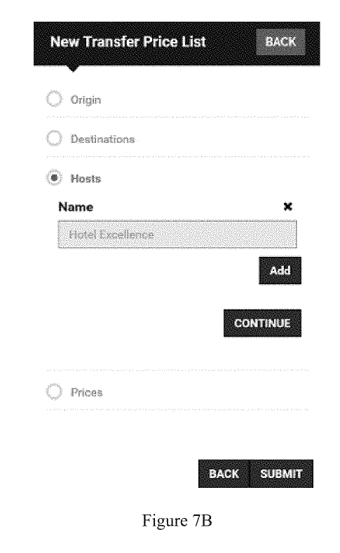

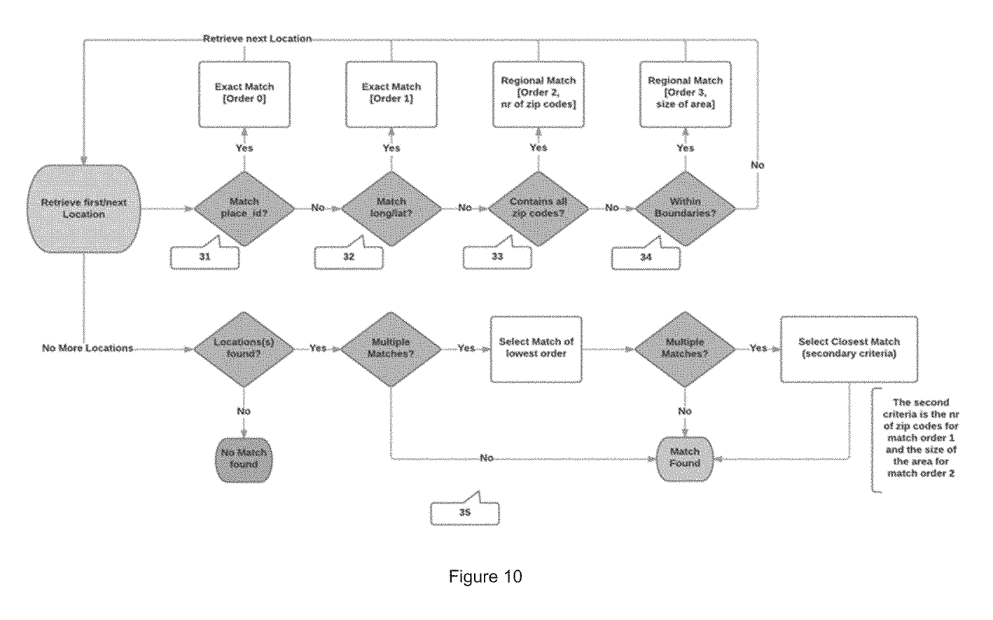

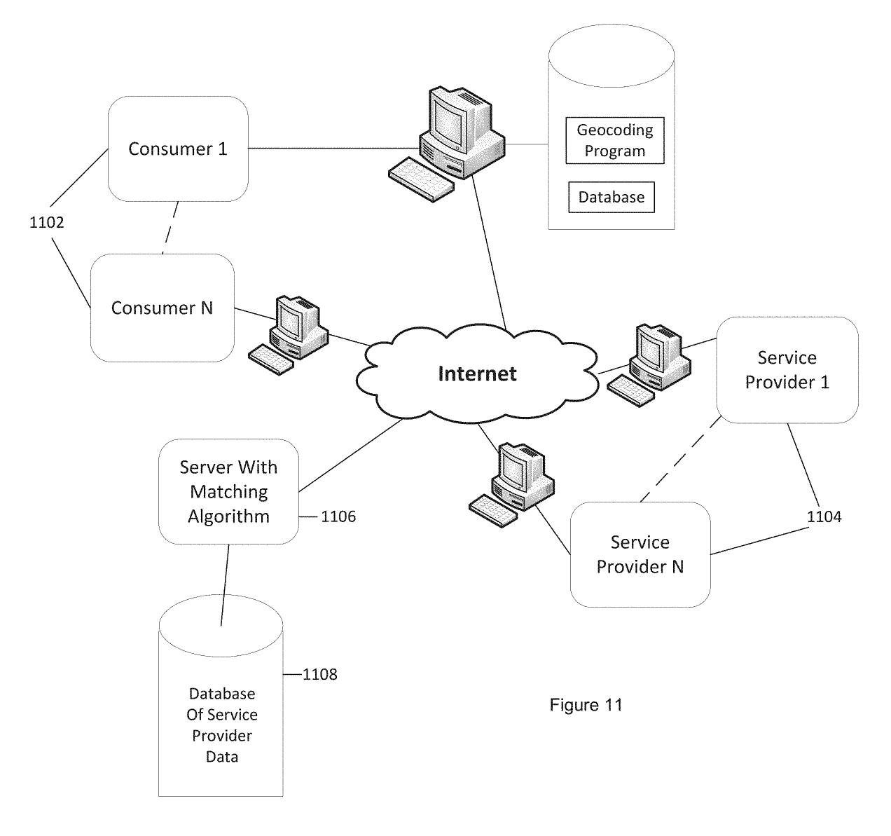

As another example, suppose it is desired to provide price matching for transportation providers. In this example, a guest wishes to book in advance a transfer from an airport to a hotel. The booking agent or guest would then enter a pickup date/time and a pick-up location (in this case an airport) as well as a drop-off location by selecting the hotel they want to transfer to into an interface such as that shown in FIGS. 3 and 4. After entering the number of guests to transfer and information about the guests in an interface such as that shown in FIGS. 5A-5C, the system calculates the price based on a price list entered by the transportation provider. As shown in FIG. 5C, the interface may also request information related to the transportation provider and the price for the guest. In accordance with the invention, this pricing is based on the pricing tier calculated using the matching algorithm described with respect to FIG. 2 (and FIG. 10 below) rather than a pre-arranged negotiated price between the booking agent and the service provider. As shown in FIGS. 6A-6C, the price list results are provided to the booking agent or user based on the geocoded locations. FIG. 6A illustrates information about the origin for creating a price list, while FIG. 6B illustrates information about the prices and seats necessary for creating a price list. FIG. 6C illustrates the seats and associated prices for the created price list. Also, as shown in FIG. 7, the booking agent or user may also add a new destination within a specific pricing tier using the sorted list 110 of service providers. FIG. 7A illustrates information about the destinations for creating a price list, while FIG. 7B shows information about the hosts for use in price list creation. In these examples, the price list can be associated with one or more hosts that allow the price to be specific to those associated hosts but not the general host population. This feature allows providers to override general price lists for specific hosts or establish a price list that only applies to certain hosts. Hosts are selected using dropdowns on the price list screens. Preferably, the dropdowns only show “trusted” hosts.

Those skilled in the art will appreciate that the system and method described herein does not hardwire locations to prices but computes prices based on geo-coded/reverse-geocoded locations. By using geocoding, the system and method described herein enables the booking agent or user to find the correct price for a transfer when all that is available are price lists based on locations for a transfer from specific location A to specific location B. The use of geocoding as described enables different location types (area, coordinates, landmarks, etc.) to be compared/matched to each other. For example, rather than determining price based on a specific deal with a hotel, the pricing is based on whether the hotel is within a certain geographic area, has a street address within a certain district, or is in a certain neighborhood (defined by a set of zip codes) within or outside the city (and should have a different price). The matching algorithm described herein may thus compare a specific location (pick-up/drop-off) on the map defined by an address, coordinates, a zip code or simply by a name (landmarks e.g.) to another location defined by zip codes, geographic coordinates or boundaries and provide a comparison result that provides an output indicative of whether there is a “match” and, if so, how good of a “match” it is.

For robustness, the matching algorithm should account for overlapping or inclusive areas/locations. The matching algorithm should also enable service providers to define a standard price for a city but separate prices for a certain district and allow the flexibility that enables service providers to provide a flat rate for transfers from JFK to all hotels in New York City but lower prices for hotels in Queens. The system and method should also provide the flexibility for service providers to provide higher prices from LaGuardia to Staten Island because of the distance and to Manhattan because of the traffic but lower prices to Queens because Queens is closer. In other words, the system and method should be able to find the “smallest” area that matches the pick-up and drop-off location of a transfer and through that “smallest” area return the “best” pricing match.

The matching algorithm provides such flexibility by geocoding locations using established geocoding services like Google Maps or Bing Maps. The information retrieved from these services is matched against the geocoded pick-up/drop-off locations for a certain transfer. The multi-step matching algorithm described with respect to FIG. 2 (and FIG. 10 below) finds the “best/closest” pricing match for a transfer. The “closeness” of a match is directly derived from the “closeness” of a match between transfer and price locations which considers unique identifiers for places/locations, coordinates (longitude/latitude), boundaries (defining an area on the map using a square or a polygon) and zip codes. A match based on coordinates is considered closer than one based on zip codes (same coordinates means it is the same location; zip code of a location being within the zip code range of a city means the location is within the city but it is not an exact match). A match from one zip code to an area with 5 zip codes is considered a closer match than one to an area with 10 zip codes which allows one to define sub-areas with different prices. It is also important to understand that the goal is not to find the lowest price but the best location match. Only if there is more than one location match of the same order, then the lowest price will be taken into consideration.

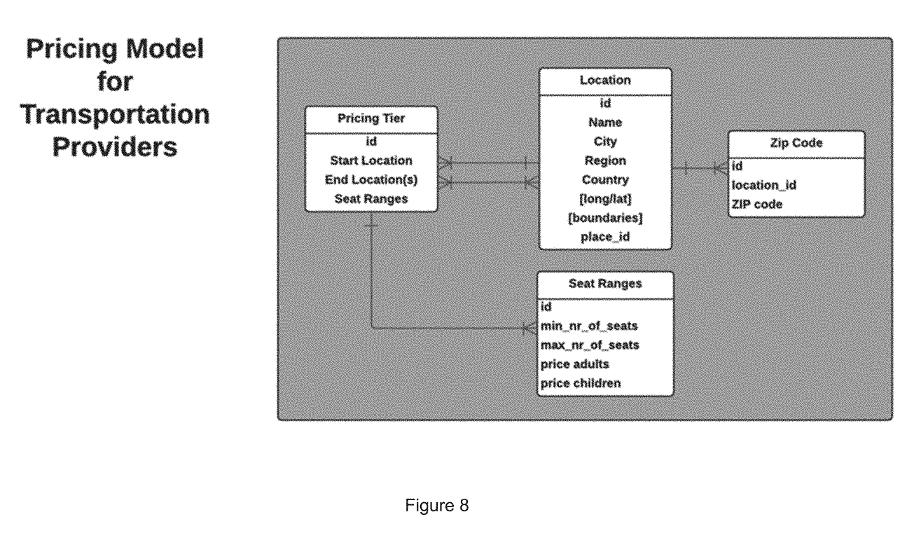

FIG. 8 illustrates a sample pricing model for transportation providers. In addition to city, region, and country, this pricing model uses geo-coded locations containing longitude/latitude [long/lat], geographical boundaries [boundaries], multiple zip codes and, if available a landmark [place_id]. Note that a landmark will not have a zip code but will probably have boundaries, while a restaurant likely will not have boundaries but will have a single zip code. The seat ranges provides typical attribute information such as minimum and maximum numbers of seats needed and adult/child pricing differential.

A location based service such as a transportation/transfer request typically has two geo-coded locations: the pick-up location and the drop-off location. The system and method described herein matches the transportation request to the location based service offerings of respective transportation providers not based on a pre-negotiated deal but based on the pricing model with pricing tiers created from the inputs illustrated by way of example in FIG. 8.

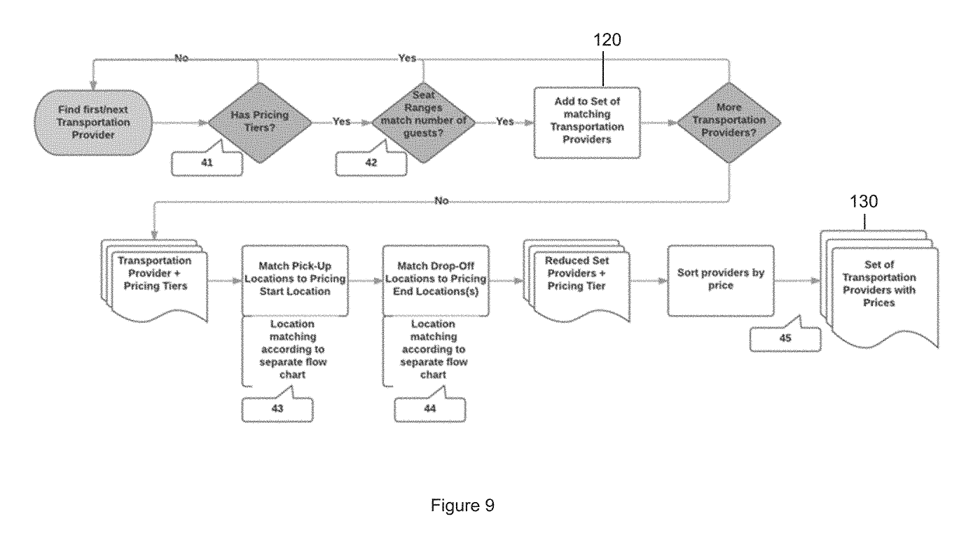

FIG. 9 illustrates the price matching for location based services as in FIG. 2 where the service is a transportation service having a tiered geo-coded pricing model in accordance with the techniques of the invention. As illustrated in FIG. 9, the transportation providers with pricing tiers are retrieved at step 41 and transportation providers are eliminated at step 42 that do not offer transfers for the required number of travelers. The remainder of the retrieved information is added to a set of matching transportation providers at 120. At step 43, the transportation providers are identified that have a pricing tier with a start location matching the pick-up location. The match is performed according to the location matching described below with respect to FIG. 10. Next, at step 44, the system finds providers that have a pricing tier with at least one end location matching the drop-off location. The match is again performed according to the location matching described below with respect to FIG. 10. The resulting provider list is then sorted by price at 45. The matching algorithm has already eliminated multiple price matches per provider based on the order of the location matches. Multiple matches per provider can happen because there can be “overlapping” price tiers. For example, a provider might want to have a price to go from one city to another but they might also want to have special prices for certain trips, e.g., due to high traffic or road usage fees. The result is a set of transportation providers with pricing in the respective tiers.

FIG. 10 illustrates a location matching/ranking algorithm in accordance with an exemplary embodiment of the invention. As illustrated, locations are retrieved and the place_id, which is a unique identifier for a place (could be an address, a landmark, a city, etc.) is compared to the identified pick-up or drop-off location at step 31. Most geocoding services have such a unique identifier and having two locations with a matching place_id means they are exactly the same location. This is considered an exact match (order 0). At step 32, the longitude/latitude coordinates of the retrieved location are compared to the identified pick-up or drop-off location. Matching long/lat coordinates correspond to a match order 1. At step 33, if a location is found to have zip codes that are a subset of another location's zip codes, then a regional match where location 1 is a sub-area of location 2 (or identical to location 2) is identified. The number of matching zip codes will be used as a second criterion to determine how close a match it is. A regional match corresponds to a match order 2. As a last criterion, the geographical boundaries are used at step 34 to compare two locations. This is considered a match order 3 and the size of the original area is used as a second criterion to determine how close the match is. The smaller the original location/area, the closer the match.

After all locations have been matched (or not), the matched locations are sorted by their order (and the second criteria) at step 35. The location with the lowest order is the closest match. If there are multiple matches, the match is selected with the best match for the secondary criteria. For example, the secondary criteria may include the number of zip codes for match order 1 and the size of the area for match order 2.

FIG. 11 is a block diagram illustrating a computer architecture of the system 1100 through which the embodiments of the location based matching system described herein may be implemented. As illustrated, a plurality of consumers 1102 connect to the Internet using their personal computer, tablet devices, smart phones, etc. and download data entry software available either locally or from a server 1106. Similarly, a plurality of location based service providers 1104 connect to the Internet using their personal computer, tablet devices, smart phones, etc. and download data entry software available either locally or from server 1106. The consumers and service provider devices include geocoding software of access same via the Internet in order to provide the geo-coding services described herein. The server 1106 further includes the matching software including the matching algorithm described herein for matching the service provider offers and consumer requests. Generally, the service provider offers including the location and other attributes of the location based services described herein are stored in database 1108 and are served to the matching algorithm for processing as described herein. These processing devices are generally well-known to those skilled in the art, and a detailed discussion thereof is omitted here for convenience only and should not be considered limiting.

The matching algorithm may also be adapted to restrict the selection process to only specific location details depending on the type of location selected. For example, the address for the colosseum in Rome is “Piazza del Colosseo, 1, 00184 Roma, Italy.” If this address is used as the origin in a price list, it should be matched only to that specific location. Due to the inclusion of the zip code, the origin may match any transfer location in the 00184 zip code. Therefore, if the origin is a specific address and not a “region” like the city of Rome or a municipality (e.g., “Municipio Roma X, Rome, Metropolitan City of Rome, Italy”), it should only match based on the Google place_id or the latitude and longitude (but not the zip code or the region's boundaries). Otherwise, the system may return unexpected price list matches. So far as a price list is concerned, the address “Piazza del Colosseo, 1, 00184 Roma, Italy” should only match the same place_id or the location's coordinates but not the address “Via di S. Giovanni in Laterano 00184 Roma, Italy.” However, the area of “Rione XIX Celio, Rome, Metropolitan City of Rome, Italy” is the origin and should match all of the locations mentioned above.

The embodiments of the present disclosure may be implemented with any combination of hardware and software. If implemented as a computer-implemented apparatus, the present disclosure is implemented using software loaded onto a processor as means for performing all of the steps and functions described above. The embodiments of the invention also may be included in an article of manufacture (e.g., one or more computer program products) having, for instance, computer useable or computer readable storage media such as RAM, ROM, DVDs, and the like, but excluding modulated signals. The media has embodied therein, for instance, computer readable program code, including computer-executable instructions, for providing and facilitating the mechanisms of the embodiments described herein. The article of manufacture can be included as part of a computer system or sold separately.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. For example, the system may incorporate warning features. In exemplary embodiments, if the user selects a pricing tier that is not the lowest predefined pricing (tier), the system will warn the user. Similarly, if the user selects a provider that does not have a predefined pricing (tier) and the user manually enters a price that is higher than the lowest predefined price (if there are any), the system will warn the user. It is understood, therefore, that the scope of the present disclosure is not limited to the particular examples and implementations disclosed herein, but is intended to cover modifications within the spirit and scope thereof as defined by the appended claims and any and all equivalents thereof.

What is claimed:

1. A method of providing location based services according to a tiered pricing model based on proximity of the location based services to desired pick-up and/or drop-off locations, comprising:
receiving offers of location based services from service providers, said offers including attributes of the offered location based services and geocoded GPS location data identifying where the location based service is offered, the geocoded location data including at least two different types of geocoding information representing areas of different sizes;
receiving from a consumer a request for location based services, the request including attributes of the requested location based services and geocode GPS location data identifying where the consumer wishes to receive the location based services, the geocoded location data including at least two different types of geocoding information representing areas of different sizes;
matching the received request to offers of location based services received from services providers, said matching including determining if there is a geographic match between a requested location and an offered location for the location based services and, if so, determining an order of the geographic match based on the type of geocoding information that is found to match; and
providing a price for the requested location based service based on the order of the geographic match.

2. The method of claim 1, wherein the location based services include delivery services, transportation services, mail/carrier services, or house call services.

3. The method of claim 1, further comprising presenting match results sorted by closeness of geographic match between a requested location and an offered location for requested location based services.

4. The method of claim 1, wherein the attributes of the location based services offered by the service providers include tiered pricing with a different price tier for each order of geographic match.

5. The method of claim 1, wherein the different types of geocoding information representing areas of different sizes include at least two of an address, longitudinal/latitudinal coordinates, zip code, geographic boundaries, or landmark name.

6. The method of claim 5, wherein when the match results have a first matching order if the requested location and offered location have identical addresses or landmark name, a second matching order if the requested location and offered location have identical longitudinal/latitudinal coordinates, a third matching order if the requested location and offered location have matching zip codes, and fourth matching order if the requested location and offered location have matching geographic boundaries.

7. The method of claim 6, wherein the price for the requested location based service increases as the order of the geographic match moves from the first to the fourth matching order.

8. The method of claim 6, wherein sub-criteria are used as tie breakers when the offered locations from different service providers have a match of the same matching order, such sub-criteria including at least one of a number of zip codes or a size of a geographic area within a geographic boundary.

9. The method of claim 1, further comprising sorting service providers offering a location based service that matches the requested location in a rank order sorted by price.

10. The method of claim 1, further comprising providing a warning to a user if the user selects a pricing tier that is not a lowest predefined pricing tier or if the user selects a provider that does not have a predefined pricing tier and the user manually enters a price that is higher than a lowest predefined price.

11. A system for providing location based services according to a tiered pricing model based on proximity of the location based services to desired pick-up and/or drop-off locations, comprising:
a database that stores offers of location based services from service providers, said offers including attributes of the offered location based services and geocoded GPS location data identifying where the location based service is offered, the geocoded location data including at least two different types of geocoding information representing areas of different sizes; and
a server that receives from a consumer a request for location based services, the request including attributes of the requested location based services and geocode GPS location data identifying where the consumer wishes to receive the location based services, the geocoded location data including at least two different types of geocoding information representing areas of different sizes, the server implementing a matching algorithm for matching the received request to offers of location based services received from services providers, said matching algorithm determining if there is a geographic match between a requested location and an offered location for the location based services and, if so, determining an order of the geographic match to the consumer that is based on the type of geocoding information that is found to match and providing in response to the request for location based services a price for the requested location based service based on the order of the geographic match.

12. The system of claim 11, wherein the location based services include delivery services, transportation services, mail/carrier services, or house call services.

13. The system of claim 11, wherein the server presents match results sorted by closeness of geographic match between a requested location and an offered location for requested location based services.

14. The system of claim 11, wherein the attributes of the location based services offered by the service providers include tiered pricing with a different price tier for each order of geographic match.

15. The system of claim 11, wherein the different types of geocoding information representing areas of different sizes include at least two of an address, longitudinal/latitudinal coordinates, zip code, geographic boundaries, or landmark name.

16. The system of claim 15, wherein when the match results have a first matching order if the requested location and offered location have identical addresses or landmark name, a second matching order if the requested location and offered location have identical longitudinal/latitudinal coordinates, a third matching order if the requested location and offered location have matching zip codes, and fourth matching order if the requested location and offered location have matching geographic boundaries.

17. The system of claim 16, wherein the price for the requested location based service increases as the order of the geographic match moves from the first to the fourth matching order.

18. The system of claim 16, wherein sub-criteria are used as tie breakers when the offered locations from different service providers have a match of the same matching order, such sub-criteria including at least one of a number of zip codes or a size of a geographic area within a geographic boundary.

19. The system of claim 11, wherein the server sorts service providers offering a location based service that matches the requested location in a rank order sorted by price.

20. The system of claim 11, wherein the server is further configured to provide a warning to a user if the user selects a pricing tier that is not a lowest predefined pricing tier or if the user selects a provider that does not have a predefined pricing tier and the user manually enters a price that is higher than a lowest predefined price.
